(19) United States
(12) Patent Application Publication
(10) Pub. No.: US 2025/0144788 A1
(43) Pub. Date: May 8, 2025

(54) SHAPE MEMORY MATERIAL ACTUATOR AND HYBRID ACTUATOR COMPRISING SAME

(71) Applicant: Sarcomere Dynamics Inc., Abbotsford (CA)

(72) Inventor: Avtar Mandaher, Abbotsford, British Columbia (CA)

(21) Appl. No.: 18/837,458

(22) PCT Filed: Feb. 10, 2022
(86) PCT No.: PCT/CA2022/050200

§ 371 Date: Aug. 9, 2024

(51) Int. Cl. B25J 9/10; B25J 15/00; B25J 15/10

(52) U.S. Cl. CPC B25J 9/1045; B25J 9/1075; B25J 9/1085; B25J 15/0009; B25J 15/10

(57) ABSTRACT

A shape memory material actuator has a frame, a pair of terminals connected to the frame, a movement mechanism movable relative to the frame, and a length of shape memory material extending between and connected to the pair of terminals. A portion of the length of shape memory material extending between the pair of terminals also extends over a surface of the movement mechanism such that contraction of the length of shape memory material applies force against and consequently displaces the movement mechanism. A hybrid actuator may include at least one of the shape memory material actuator, as well as a non-back drivable non-shape memory material actuator connected to the frame. The hybrid actuator may be used inside a robotic manipulator to control a joint that bends in response to movement of a floating pulley through which an artificial tendon connected to the hybrid actuator is threaded.

### TECHNICAL FIELD

The present disclosure is directed at a shape memory material actuator, and at a hybrid actuator comprising the shape memory material actuator.

### BACKGROUND

The human hand is an impressive biomechanical device. It can be positioned in any number of different orientations, carefully approach an object for gripping in a variety of distances and speeds, and, if necessary, quickly apply a gripping force to that object that is well in excess of the force that was required to initially move the hand near the object. Further, it does this while being relatively small and light. Consequently, efforts to create robotic manipulators have largely focused on mimicking the hand's desirable traits.

### SUMMARY

According to a first aspect, there is provided a shape memory material actuator comprising: a frame; a pair of terminals connected to the frame; a movement mechanism movable relative to the frame; and a length of shape memory material extending between and connected to the pair of terminals, wherein a portion of the length of shape memory material extending between the pair of terminals also extends over a surface of the movement mechanism such that contraction of the length of shape memory material applies force against and consequently displaces the movement mechanism.

The shape memory material actuator may further comprise: a first group of one or more pulleys at one angular position about the movement mechanism; and a second group of one or more pulleys at another angular position about the movement mechanism. Respective portions of the length of shape memory material may be reeved through the first and second groups of pulleys and the portion of the length of shape memory material that applies force against the movement mechanism may be between the portions of the length of shape memory material that are reeved through the first and second groups of pulleys.

Each of the pulleys may sit on an electrically insulative axle and comprise a metallic sheave.

The movement mechanism may comprise a channel through which the length of shape memory material extends, wherein the surface against which the length of shape memory material applies force comprises a wall of the channel; and the first group of one or more pulleys may comprise a first block and tackle comprising opposing sets of pulleys, the second group of one or more pulleys may comprise a second block and tackle comprising opposing sets of pulleys, and the channel may be axially positioned along the movement mechanism between the opposing sets of pulleys that comprise the first block and tackle and between the opposing sets of pulleys that comprise the second block and tackle.

The contraction of the length of shape memory material may cause the movement mechanism to move from an unactuated position to an actuated position, and the shape memory material actuator may further comprise a spring positioned to bias the movement mechanism from the actuated position back to the unactuated position.

The spring may bias the wall of the channel of the movement mechanism against the frame when the movement mechanism is in the unactuated position.

The shape memory material may comprise a shape memory alloy that contracts in response to an electrical signal.

The frame may be electrically insulative.

The shape memory material actuator may further comprise a current sensor electrically coupled to the first pair of terminals for measuring stress experienced by the length of shape memory material.

The shape memory material actuator may further comprise an infrared position sensor aligned with the movement mechanism and positioned to emit infrared light towards the movement mechanism. A tip of the movement mechanism may be convex and infrared reflective.

The movement mechanism may comprise a piston.

According to another aspect, there is provided a hybrid actuator, comprising: a first shape memory material actuator comprising the shape memory material actuator of any of the foregoing aspects or suitable combinations thereof; and a non-back drivable non-shape memory material actuator connected to the frame.

The non-shape memory material actuator may comprise: a worm gear direct current electric motor; and an output pulley powered by the worm gear direct current electric motor. More generally, and regardless of whether the non-shape memory material actuator is of a different type, a worm gear, which is self-locking, is one way in which the non-shape memory material actuator may be made to be non-back drivable.

The frame may comprise a printed circuit board; and the pair of terminals and the worm gear direct current electric motor may be mounted to the printed circuit board.

The hybrid actuator may further comprise one or more additional shape memory material actuators. Each of the one or more additional shape memory material actuators may comprise the shape memory material actuator of any of the foregoing aspects or suitable combinations thereof. The movement mechanisms of the first shape memory material actuator and of the one or more additional shape memory material actuators may be secured together.

According to another aspect, there is provided a robotic manipulator, comprising: an end effector comprising a robotic joint, wherein the robotic joint comprises a floating pulley and wherein movement of the floating pulley causes bending of the robotic joint; a hybrid actuator, comprising: a first shape memory material actuator; and a non-back drivable non-shape memory material actuator; and an artificial tendon connected to the first shape memory material actuator and the non-shape memory material actuator, wherein a portion of the artificial tendon between where the artificial tendon is connected to the first shape memory material actuator and the non-shape memory material actuator is reeved through the floating pulley.

The first shape memory material actuator may comprise the shape memory material actuator of any of the foregoing aspects or suitable combinations thereof, and the artificial tendon may be connected to the movement mechanism of the first shape memory material actuator.

The non-shape memory material actuator may comprise: a worm gear direct current electric motor; and an output pulley powered by the worm gear direct current electric motor. At least some of the second artificial tendon may be reeved through the output pulley. More generally, and regardless of whether the non-shape memory material actuator is of a different type, a worm gear, which is self-locking, is one way in which the non-shape memory material actuator may be made to be non-back drivable

The frame may comprise a printed circuit board; and the pair of terminals and the worm gear direct current electric motor may be mounted to the printed circuit board.

The robotic manipulator may further comprise one or more additional shape memory material actuators, with each of the one or more additional shape memory material actuators comprising the shape memory material actuator of any of the foregoing aspects or suitable combinations thereof. The movement mechanisms of the first shape memory material actuator and of the one or more additional shape memory material actuators may be secured together.

The one or more additional shape memory material actuators may be secured together using one or more connectors, and the first artificial tendon may be attached to the one or more connectors.

The robotic manipulator may further comprise a controller communicatively coupled to the hybrid actuator and configured to: use the non-shape memory material actuator to move the end effector to a first position; and when the end effector is at the first position, use the first shape memory material actuator to apply a gripping force to an object using the end effector.

The robotic manipulator may comprise a robotic hand and the hybrid actuator may be located and the hybrid actuator is located outside of a finger comprising part of the robotic hand.

According to another aspect, there is provided a method for using the robotic manipulator of any of the foregoing aspects or suitable combinations thereof, the method comprising: using the non-shape memory material actuator to move the end effector to a gripping position; and when the end effector is in the gripping position, using the first shape memory material actuator to apply a gripping force to an object using the end effector.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 depicts a robotic hand comprising a hybrid actuator, according to an example embodiment.

FIG. 2A depicts the hybrid actuator and a robotic phalange comprising part of the robotic hand of FIG. 1, according to an example embodiment.

FIG. 2B depicts a sectional view of the robotic phalange of FIG. 2A, taken along line 2B-2B of FIG. 2A.

FIG. 3 depicts a perspective view of the hybrid actuator of FIG. 2A in an unactuated state.

FIG. 4 depicts a top view of the hybrid actuator of FIG. 2A in an unactuated state.

FIGS. 5 and 6 respectively depict front and rear elevation views of the hybrid actuator of FIG. 2A in an unactuated state.

FIGS. 7 and 8 respectively depict right and left side elevation views of the hybrid actuator of FIG. 2A in an unactuated state.

FIGS. 9 and 10 respectively depict front and rear elevation views of the hybrid actuator of FIG. 2A in an actuated state.

FIG. 11 depicts a front elevation view of the hybrid actuator of FIG. 2A in an unactuated state with a frame of one of the shape memory material actuators comprising part of the hybrid actuator removed to reveal the interior of the hybrid actuator.

FIG. 12 depicts a block diagram of circuitry that comprises part of the hybrid actuator of FIG. 2A.

FIG. 13 depicts a method for using a robotic manipulator in conjunction with a hybrid actuator, according to another example embodiment.

### DETAILED DESCRIPTION

Robotic manipulators, such as robotic hands used for artificial limbs and robotic end effectors used for industrial operations such as assembly and sorting, are becoming increasingly prevalent. In part this is because of the advance of artificial intelligence-based technologies in the field of computer vision, for example, which is permitting greater recognition and manipulation of objects by manipulators.

Regardless of a robotic manipulator's application, generally speaking in order to grip an object the manipulator's end effector is first positioned in a “gripping position” that is proximate to that object and is then used to apply a gripping force to that object. The characteristics of the force used to move the end effector to the gripping position and of the gripping force itself are markedly different. Namely, when positioning the end effector into the gripping position and prior to gripping, a relatively low amount of force is typically required to move the end effector a relatively large distance. In contrast, the gripping force itself is relatively large and moves the end effector only a small distance, if at all.

A direct current electric motor (“DC motor”) may be used as an actuator for an end effector. While a reasonably sized DC motor can be used to move an end effector a long distance, DC motors suffer from relatively low power-to-weight ratios. Consequently, a DC motor is a poor choice for generating an end effector's gripping force, particularly when used as an artificial limb, given the large weight and size of the DC motor that would be required. In contrast, a shape memory alloy (“SMA”), which is a metallic alloy that deforms in response to a change in temperature, may also be used as an actuator for an end effector. SMAs have a higher power-to-weight ratio than DC motors and tend to have relatively small (e.g., between approximately 4% and approximately 8%) recoverable deformation. This makes SMAs more suitable for use in generating an end effector's gripping force than a DC motor.

In view of the complementary characteristics of SMAs and DC motors, attempts to combine a DC motor with an SMA actuator in the context of an actuator have been made. However, these attempts suffer from one or more technical problems such as unacceptably high position inaccuracy (e.g., approximately 5% deviation); SMA orientations that lead to high stresses being applied to the SMA and consequently a relatively short SMA operational lifetime and/or reduced SMA performance; an inability to directly monitor forces generated by the SMA; bulky mechanical designs not conducive to the miniaturization required to fit the actuators in an artificial hand; and interference between actuation caused by the DC motor vs. the SMA.

In at least some embodiments herein, a shape memory material (“SMM”) actuator and a hybrid actuator that comprises the SMM actuator are described. An SMM is a resiliently deformable material that deforms in response to a change in temperature. While one example of an SMM is an SMA, other examples of an SMM are polymer-based (e.g., they comprise at least one polymer and may exclude any metallic alloys), for example. The SMM actuator generally comprises a frame; a pair of terminals connected to the frame; a movement mechanism movable relative to the frame; and a length of SMM extending between and connected to the pair of terminals. The length of SMM used in the depicted embodiments is a filament of SMM; generally speaking, a “filament” may comprise, for example, a fiber, rope, string, strand, cord, thread, or ribbon. More generally, any suitably shaped length of SMM may be used within the SMM actuator. For example, the length of SMM may comprise flat sheets of a polymer-based SMM that are arranged so as to be capacitive, or a bar of SMM.

A portion of the filament extending between the pair of terminals also extends over a surface of the movement mechanism such that contraction of the filament applies force against and consequently displaces the movement mechanism. The contraction may result, for example, from application of an electrical signal across the terminals such that the SMM heats up and consequently contracts. Various pulleys positioned about the movement mechanism may be used to increase the length of SMM that the actuator can contain in a space efficient manner while keeping stress experienced by the SMM relatively low, thereby increasing the amount of force the SMM actuator can generate in a space efficient manner. Multiple of the SMM actuators may be aligned and their movement mechanisms connected together, thereby further increasing the aggregate output force available from a single apparatus again in a space efficient manner. A hybrid actuator may comprise one or more of the SMM actuators and another non-SMM actuator, such as a DC motor, with the 1) output of the one or more SMM actuators and 2) output of the non-SMM actuator respectively connected to first and second artificial tendons. The non-SMM actuator and the one or more SMM actuators may then be respectively used to position the robotic manipulator, such as an artificial limb, into a gripping position and to apply a gripping force to an object without interfering with each other.

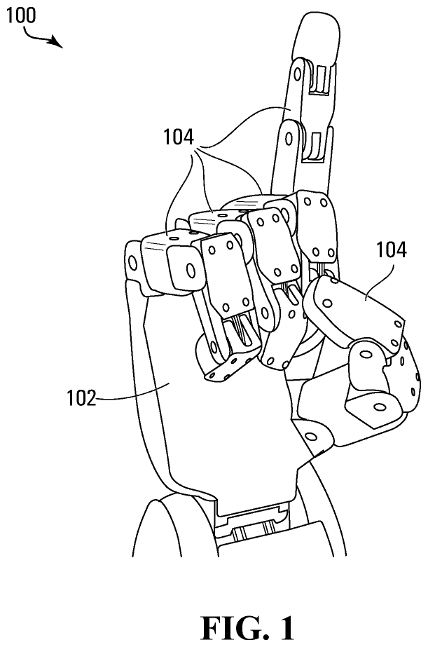

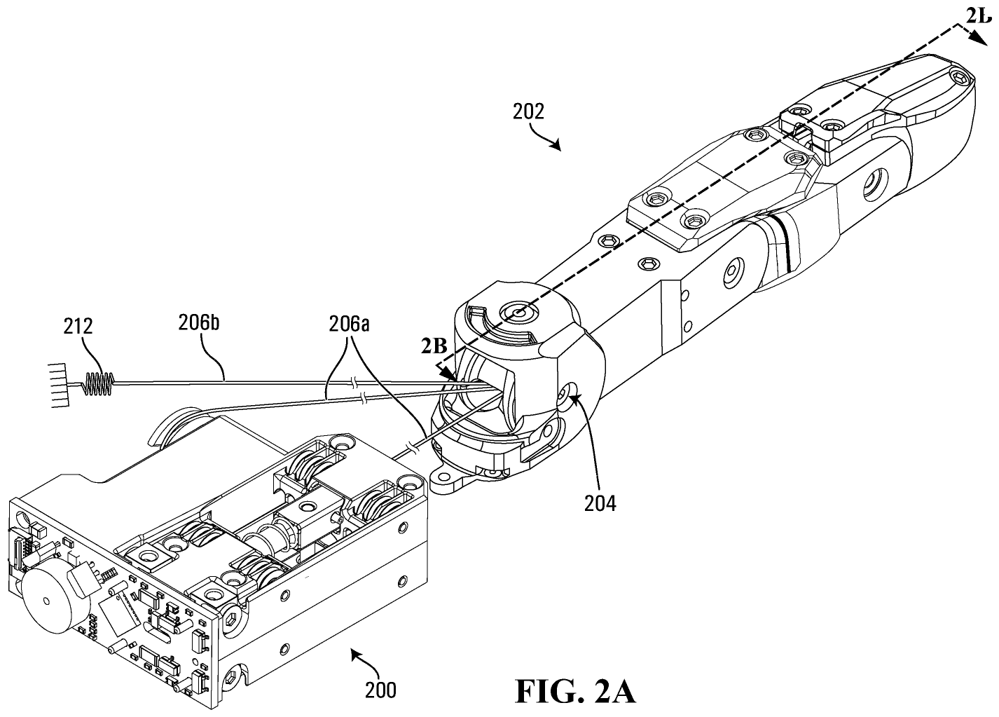

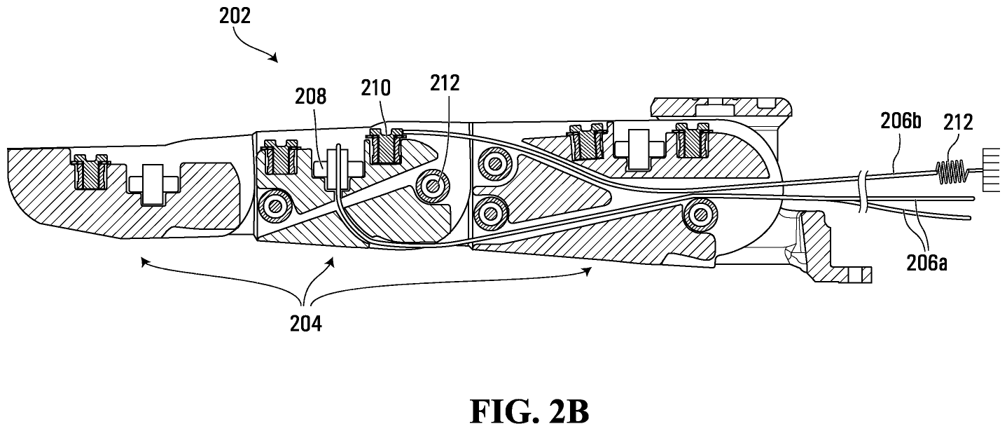

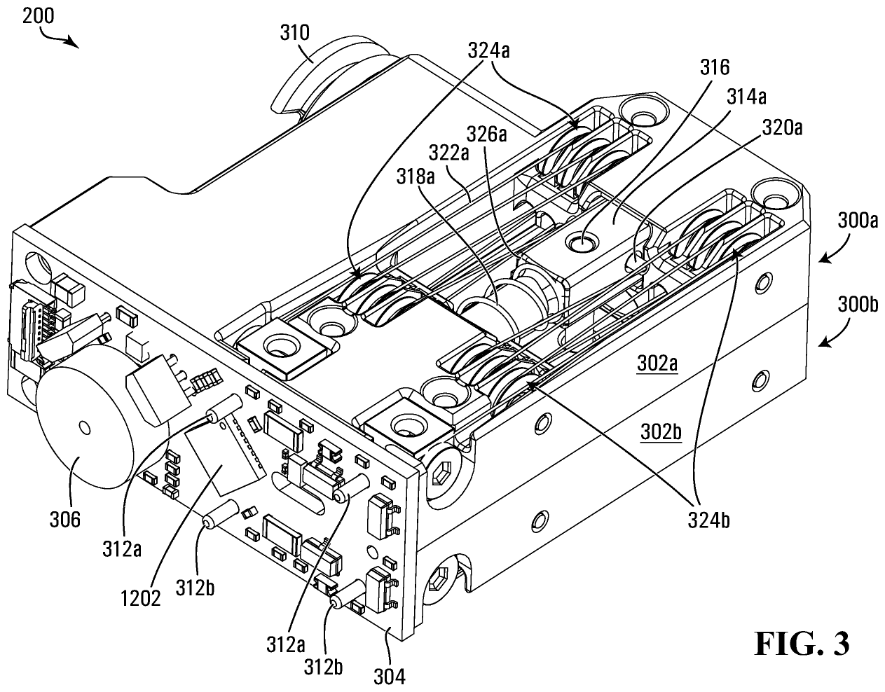

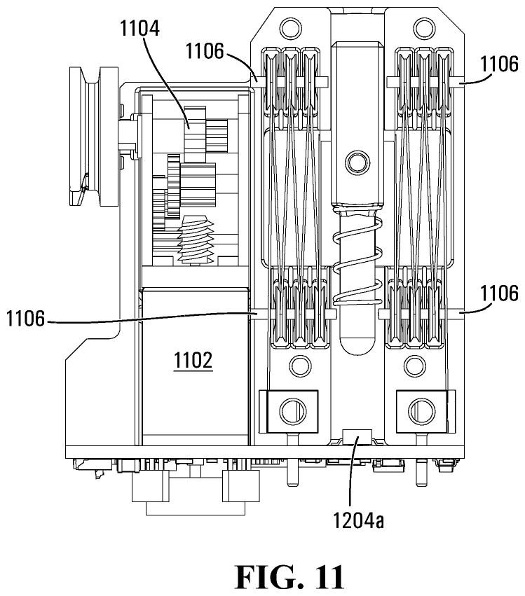

Referring now to FIG. 1, there is depicted a perspective view of a robotic hand 100, which is an example of a robotic manipulator, according to an example embodiment. The robotic hand 100 comprises a palm 102 and five fingers 104, with each of the fingers 104 comprising a proximal, middle, and distal phalanx. Located within the palm 102 is a hybrid actuator 200, such as that depicted in FIG. 2A. In FIG. 2A, the hybrid actuator 200 is shown connected to a robotic joint 204 at the base of one of the middle phalanges 202 of the hand 100 via first and second artificial tendons 206a,b. FIG. 2B shows a cross-section of the robotic joint 204 taken along line 2B-2B of FIG. 2A. The artificial tendons 206a,b may be constructed, for example, from a nylon coated, braided steel cable. FIG. 2B depicts three robotic joints 204 delineating the proximal, middle, and distal phalanxes of the robotic hand 100, with a floating pulley 208, bolt 210, and mandrel 212 of only the middle phalanx labeled for clarity of illustration. A first portion of the first artificial tendon 206a (e.g., a first end of the artificial tendon 206a) is connected to movement mechanisms 314a,b (shown in FIGS. 3, 5, 6, and 9-11) comprising part of first and second SMM actuators 300a,b; a second portion of the first artificial tendon 206b (e.g., a second end of the artificial tendon 206b) is connected to an output pulley 310 of the hybrid actuator 200, which is powered by a DC motor 1102 (shown in FIG. 11); and a third portion of the artificial tendon 206a between the first and second portions is reeved through the floating pulley 208. The different ends of the artificial tendon 206a can accordingly be respectively actuated by the DC motor 1102 and by the SMM actuators 300a,b. Actuation by one or both of the DC motor 1102 and by the SMM actuators 300a,b translates the entire floating pulley 208 through space, thereby bending the robotic joint 204 and causing rotation about the mandrel 212. A tension spring 212 is attached to the second artificial tendon 206b, which is affixed to the bolt 210. The tension spring 212 is affixed to an attachment point located within the palm 102, for example, which restores the robotic joint 204 to a straight position absent actuation by the DC motor 1102 and SMM actuators 300a,b.

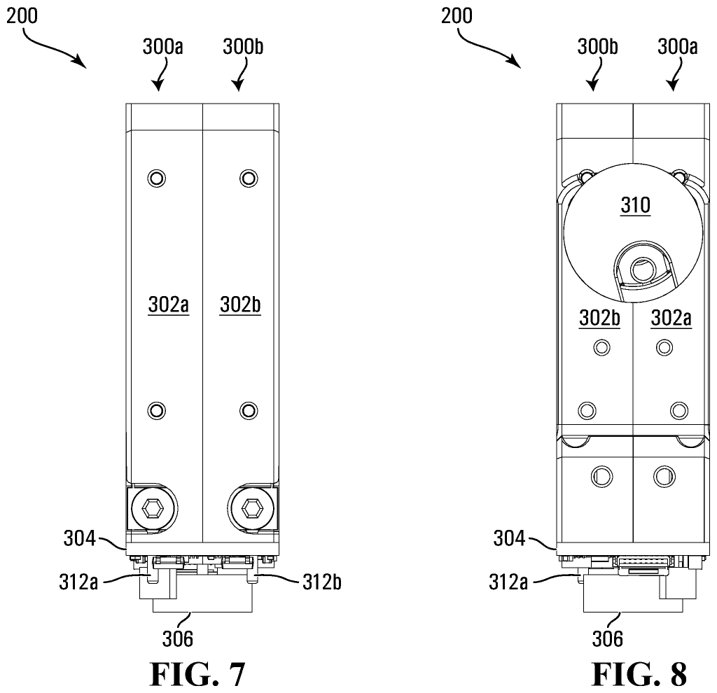

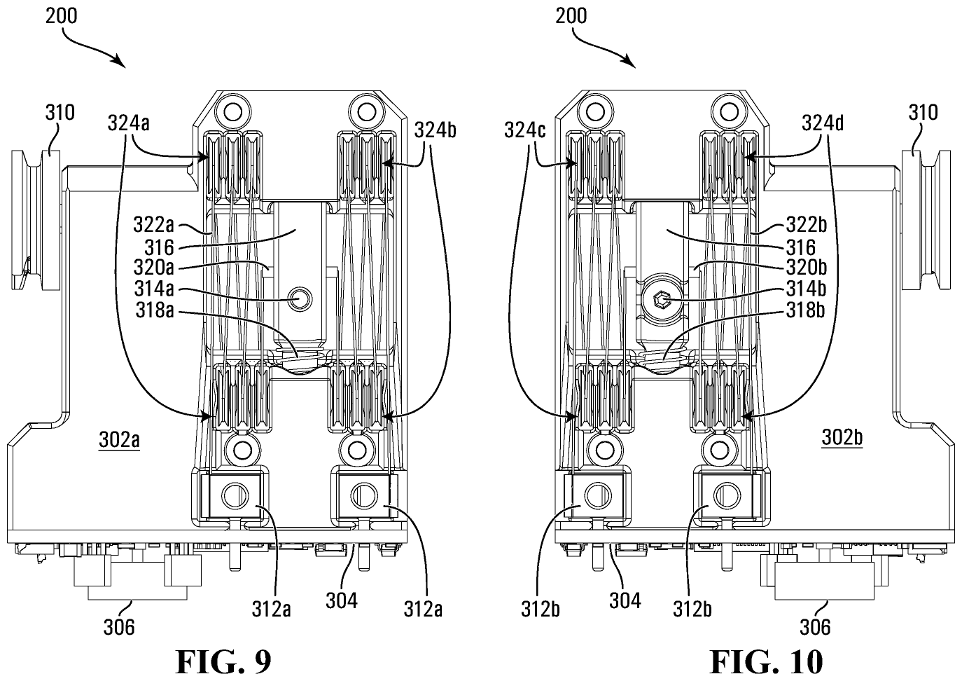

Referring now to FIGS. 3-8, there are respectively depicted perspective, top, front and rear elevation, and right and left side elevation views of the hybrid actuator 200 shown in FIG. 2A in an unactuated state. FIGS. 9 and 10 respectively depict front and rear elevation views of the hybrid actuator of FIG. 2A in an actuated state. As shown in FIG. 3 in particular, the hybrid actuator 200 generally comprises adjacent first and second SMM actuators 300a,b respectively comprising first and second frames 302a,b. FIG. 11 depicts the first frame 302a removed from the hybrid actuator 200 to display the hybrid actuator's 200 interior. The following description of the hybrid actuator's 200 structure is done with reference to FIGS. 3-11.

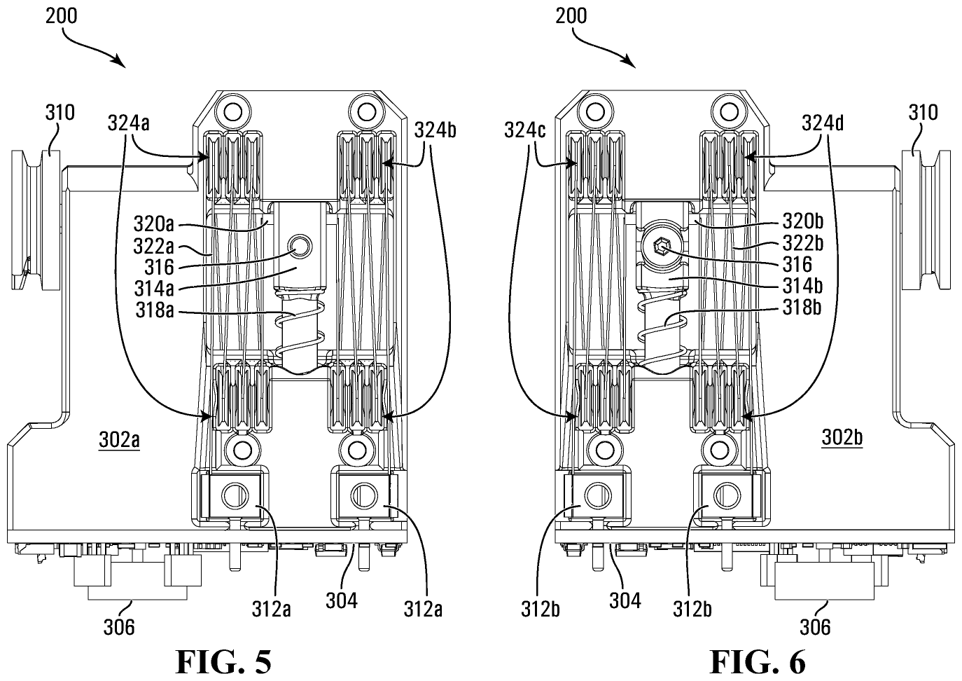

More particularly, the hybrid actuator 200 comprises the adjacent first and second SMM actuators 300a,b and a non-SMM actuator in the form of a DC motor 1102, which may be brushed or brushless. While the DC motor 1102 is used as an example non-SMM actuator in the depicted embodiment, alternative types of non-SMM actuators are possible in different embodiments. Example alternative types of non-SMM actuators comprise an AC motor, a hydraulic system, a pneumatic system, and a solenoid based system; generally speaking, these non-SMM actuators are capable of providing a large range of motion to cause the robotic joint 204 to move a corresponding degree into the gripping position. In the depicted embodiment, the first and second SMM actuators 300a,b are identical. Focusing presently on the first SMM actuator 300a, the first SMM actuator 300a comprises the first frame 302a, a first pair of terminals 312a connected to the first frame 302a, a first movement mechanism 314a movable relative to the first frame 302a, and a first filament of shape memory material (“SMM filament”) 322a that extends between and is connected to the pair of terminals 312a. The frame 302a and pair of terminals 312a are mounted to a PCB 304 on a bottom of the hybrid actuator 200. The SMM filament 322a in the depicted embodiment comprises an SMA, such as Flexinol™, which is a type of Nitinol™ nickel titanium alloy; however, other suitable SMAs or SMMs may be used. A portion of the SMM filament 322a that extends between the pair of terminals 312a also extends over a surface of the movement mechanism 314a such that contraction of the SMM filament 322a applies force against and consequently displaces the movement mechanism 314a, thereby transitioning the SMM actuator 300a to its “actuated state” as shown in FIG. 9; for clarity, FIG. 9 shows the SMM actuator 300a in its “fully actuated state”, while more generally the actuated state includes any state in which the SMM filament 322a is contracted such that the movement mechanism 314a is shifted downwards relative to its position as shown in FIG. 5 even if the movement mechanism 314a is not shifted as far down as shown in FIG. 9. The SMM filament 322a contracts in response to an electrical signal applied across its terminals 312a, which causes a current to flow through and consequently heat and contract the SMM filament 322a. In the depicted embodiment, the movement mechanism 314a comprises a piston that is axially displaced downwards towards the PCB 304 during actuation, although in other embodiments (not depicted) actuation of the SMM actuator 300a may result in a different type or direction of motion (e.g., rotational motion, or non-axial translational motion).

The SMM actuator 300a comprises a first block and tackle 324a comprising opposing sets of pulleys at one angular position about the movement mechanism 314a and a second block and tackle 324b comprising opposing sets of pulleys at another angular position about the movement mechanism 314a. As depicted the first and second block and tackles 324a,b are separated by 180 degrees in the depicted embodiment (i.e., the first and second block and tackles 324a,b and the movement mechanism 314a are aligned), although they may have a different angular separation in other embodiments. More generally, the block and tackles 324a,b are respective examples of a first and a second group of one or more pulleys through which the SMM filament 322a is reeved, with the portion of the SMM filament 322a applying force against the movement mechanism 314a during actuation being between the portions of the SMM filament 322a that are respectively reeved through the first and second groups of pulleys.

In the depicted embodiment each of the pulleys comprises sheaves manufactured using 7075 Aluminum with 1 mm×3 mm×1 mm steel micro bearings to reduce friction during contraction and relaxation of the SMM filament 322a in response to application and removal of the electrical signal across the terminals 312a, respectively. 7075 Aluminum is used due to its hardness, which helps to prevent the pulleys from being deformed when under pressure from the SMM filament 322a; in practice, the pulleys are designed to resist stresses ranging, for example, from 1,850 psi to 2,250 psi (12.76 kPa to 15.51 kPa). The aluminum also has a heat capacity low enough to prevent the pulleys from storing excessive residual heat from the SMM filament 322a, while still allowing them to practically function as heat sinks during the SMM filament's 322a relaxation. The steel micro bearings have a lower thermal conductivity than the aluminum sheaves, and further serve to thermally isolate the pulleys' axles 1106.

As the SMM filament 322a is electrically conductive, when the electrical signal is applied across the terminals 312a it is desirable to prevent any two points along the length of the SMM filament 322a from being electrically shorted together by virtue of current being conducted through anything but the SMM filament 322a itself. Given that the SMM filament 322a and the pulleys' aluminum sheaves are electrically conductive, to prevent electrical shorting when the SMM actuator 300a is in the actuated state the pulleys sit on electrically insulative axles 1106; more particularly, in the depicted embodiment the axles 1106 are fiberglass rods. Additionally, the frame 302a itself is manufactured from an electrically insulative material, such as glass composite resin; for example, the frame 302a may be 3D printed out of Rigid 10k™ resin and thermally cured to facilitate a relatively high strength and operating temperature.

The movement mechanism 314a comprises a first hollow rod 320a extending between and protruding from opposite sides of the movement mechanism 314a; more particularly, the rod 320a protrudes from the sides of the movement mechanism 314a respectively facing the first and second block and tackles 324a,b and extends through the movement mechanism 314a, thereby defining a channel through which the SMM filament 322a passes and acting as the channel wall. The rod 320a and consequently channel are axially positioned along the movement mechanism 314a between the opposing sets of pulleys that comprise the first block and tackle 324a and between the opposing sets of pulleys that comprise the second block and tackle 324b. The movement mechanism 314a also extends through a coil spring 318a biased against the frame 302a and a first lip 326a on the movement mechanism 314a. When the SMM actuator 300a is in the fully actuated state as shown in FIGS. 9 and 10, the contracted SMM filament 322a forces the lip 326a against a bottom portion of the frame 302a. When the SMM actuator 300 is unactuated, the spring 318a biases the lip 326a until the rod 320a contacts a top portion of the frame 302a. In this way, the spring 318a helps to transition the movement mechanism 314a from the actuated to the unactuated positions, and also keeps the movement mechanism 314a in the unactuated position until the electrical signal is applied against the terminals 312a. The spring 318a also helps the SMM filament 322a stay in tension when unactuated so as to prevent the SMM filament 322a from slipping out of the pulleys.

While in the depicted embodiment the movement mechanism 314a is between the two block and tackles 324a,b, in different embodiments (not depicted) different configurations are possible. The movement mechanism 314a may, for example, be adjacent one edge of the frame 302a and the block and tackles 324a,b may be located adjacent each other and between the movement mechanism 314a and the other edge of the frame 302b. As another example, as opposed to the block and tackles 324a, b and the movement mechanism 314a being co-planar, the first block and tackle 324a may be in one plane, the second block and tackle 324b may be in a different second plane, and the movement mechanism 314a may be positioned between those two planes.

The rod 320a may be made of any suitable material, such as metal (e.g., brass or aluminum) or ceramic. And while the spring 318a in the depicted embodiment is a coil spring through and along which the movement mechanism 314a extends, in different embodiments (not depicted) the spring 318a may take a different form. For example, the spring 318a in a different embodiment may comprise a coil spring that is not on the movement mechanism 314a, or a leaf spring.

The second SMM actuator 300b is identical in construction in the depicted embodiment to the first SMM actuator 300a. The first frame 302a, first pair of terminals 312a, first movement mechanism 314a, first spring 318a, first rod 320a, first SMM filament 322a, first and second block and tackles 324a,b, and first lip 326a of the first SMM actuator 300a are respectively analogous to a second frame 302b, second pair of terminals 312b, second movement mechanism 314b, second spring 318b, second rod 320b, second SMM filament 322b, third and fourth block and tackles 324c,d, and a second lip 326b of the second SMM actuator 300b. While the first and second SMM actuators 300a,b are identical in the depicted embodiment, in different embodiments (not depicted) they need not be. For example, the two actuators 300a,b may comprise a different number of pulleys, different types and/or lengths of SMM, and/or different SMM orientations.

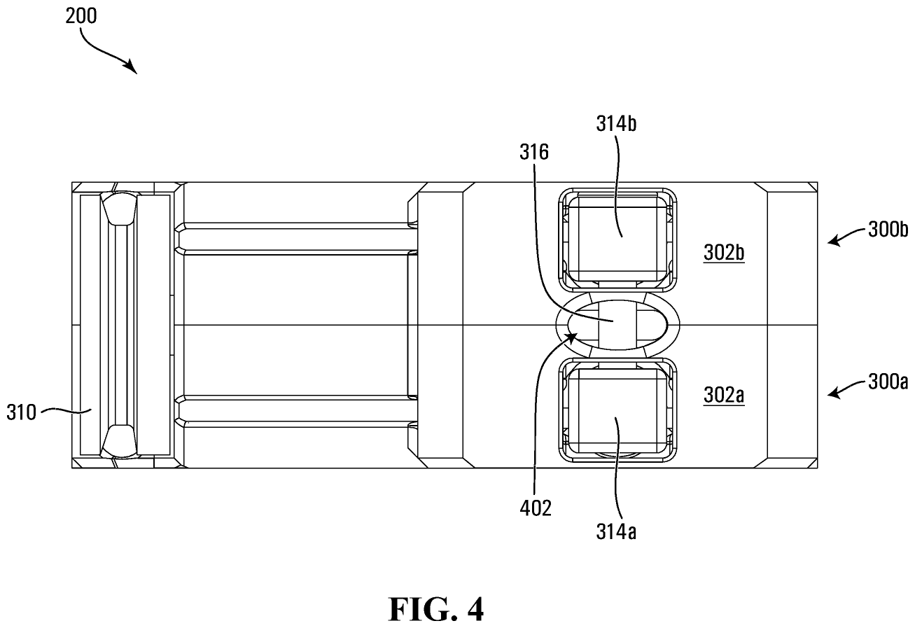

A connector in the form of a bolt 316 connects the first and second movement mechanisms 314a,b together. The bolt 316 extends perpendicularly to the movement mechanisms 314a,b in the depicted embodiment. As shown in FIG. 4, the tops of each of the first and second frames 302a,b comprise slots that collectively form an aperture 402 that allows the first artificial tendon 206a to be connected to the bolt 316. By virtue of the bolt 316 connecting the movement mechanisms 314a,b together, the total force exerted on the first artificial tendon 206a is the sum of the forces produced by each of the SMM actuators 300a,b. The use of the pulleys in the SMM actuators 300a,b in the depicted embodiment also allows the lengths of the SMM filaments 322a,bto be increased in a space efficient manner relative to an embodiment lacking pulleys. The pulleys and the bolt 316 accordingly both contribute to increasing the amount of force that the SMM actuators 300a,b can collectively generate and apply to an artificial tendon relative to known conventional systems.

Referring now particularly to FIG. 11, a non-SMM actuator is adjacent the SMM actuators 300a,b. In the depicted embodiment the non-SMM actuator comprises a DC motor 1102 that is mechanically coupled to the output pulley 310 by a worm gear 1104 (the DC motor 1102 and worm gear 1104 are collectively a “worm gear DC motor”), thereby permitting the DC motor 1102 to power the output pulley 310. While the depicted embodiment shows the DC motor 1102 as the non-SMM actuator, in different embodiments (not depicted) the non-SMM actuator may alternatively comprise a different type of actuator as discussed above. By virtue of the worm gear, the worm gear DC motor is self-locking and consequently non-back drivable; accordingly, tension applied to the worm gear through the artificial tendon 206a, such as when the SMM actuators 300a,b are being used to apply a gripping force, does not move the worm gear 1104 or DC motor 1102 and inadvertently change the joint's 204 position. While a worm gear is used to make the DC motor 1102 non-back drivable, different mechanisms, such as a ratchet, may be used in different embodiments, including those different embodiments that use a type of non-SMM actuator other than the DC motor 1102 such as the AC motor, hydraulic system, pneumatic system, or solenoid based system mentioned above.

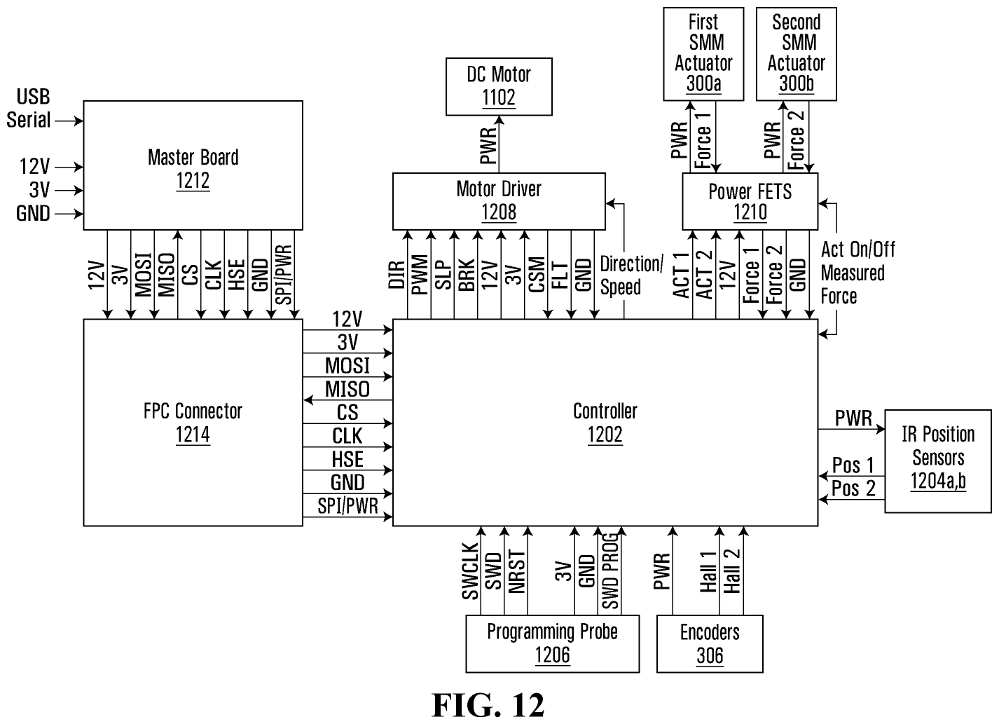

FIG. 12 depicts a block diagram 1200 of circuitry that comprises part of the hybrid actuator of FIG. 2A. The block diagram 1200 shows a controller 1202 that may comprise, for example, an STM32™ microcontroller. The controller 1202 is communicatively coupled to first and second infrared (“IR”) position sensors 1204a,b used to monitor the positions of each of the first and second SMM filaments 322a,b; an encoder 306 used to monitor the position of the DC motor 1102, which returns a digital signal representative of the DC motor's 1102 position (i.e., how much the DC motor's 1102 output shaft has rotated); a programming probe 1206 used to program the controller 1202; a motor driver 1208 for driving the DC motor 1102, and more particularly for controlling the direction and speed of the DC motor 1102; and power field effect transistors (“FETs”) 1210 for applying the electrical signal to the first and second pairs of terminals 312a,b to respectively actuate the first and second actuators 300a,b. The encoder 306 comprises a cylindrical rotating magnet and a pair of Hall Effect sensors that react to the magnet's position by respectively outputting the “Hall 1” and “Hall 2” signals in the block diagram 1200. The “Force 1” and “Force 2” signals in the block diagram 1200 represent a signal representative of current flowing through the first and second SMM filaments 322a,b as measured through first and second shunt resistors, respectively, thereby allowing direct measurement of the forces the first and second SMM filaments 322a,b are experiencing.

The controller 1202, IR position sensors 1204a,b, programming probe 1206, motor driver 1208, power FETs 1210, and encoder 302 are all mounted to the PCB 304. The block diagram 1200 also shows a master board 1212 that receives USB serial and power inputs, and that outputs power, clock, and various other signals to the controller 1202 via a flexible printed cable connector 1214. The master board 1212 is located in a suitable position outside the palm 102 of the robotic hand 100, such as in a compartment (not depicted) connected to the base of the hand 100.

As shown in FIG. 11 in respect of the first SMM actuator 300a, the first IR position sensor 1204a is aligned with the longitudinal axis of the piston that comprises the first movement mechanism 314a. The IR position sensor 1204a outputs IR light and receives a reflection of the emitted IR light from the tip of the first movement mechanism 314a, and subsequently determines the distance of the tip of the movement mechanism 314a from the sensor 1204a from the transit time of the reflected IR signal. To facilitate proper reflection of the IR light, the tip of the movement mechanism 314a is convex, and in the depicted embodiment is hemispherical. Additionally, the tip of the movement mechanism 314a and the portion of the frame 302a exposed to the IR light are IR reflective (e.g., painted white) so that the IR position sensor 1204a is able to measure a sufficiently intense reflected IR signal. In another embodiment (not depicted), the frame 302a may not be sufficiently near the tip of the movement mechanism 314a to warrant being IR reflective.

As mentioned above and as shown in FIG. 2A, the first artificial tendon 206a is connected to the bolt 316 on one end, passes through the aperture 402, is reeved through the floating pulley 208, and has an opposite end connected to the output pulley 310. The hybrid actuator 200 can accordingly actuate the robotic joint 204, and more generally any suitable end effector, using the different types of forces output by the DC motor 1102 and the SMM actuators 300a,b to apply tension to the ends of the artificial tendon 206a that are reeved through the floating pulley 208. This causes the entire floating pulley 208 (i.e., sheave and axle) to move through space, thereby causing the finger 104 to bend. Threading the artificial tendon 206a through the floating pulley 208 in this manner results in lower precision error and higher gripping strength than if the pulley's gripping strength resulted from the SMM filament 322a being directly connected to the floating pulley's 208 axle. For clarity, and as mentioned above, actuation of the SMM actuators 300a,b includes actuation resulting from contraction of the SMM filaments 322a,b that only partially shifts the movement mechanisms 314a,b such that the hollow rods 320a,b are not biased against the bottom portion of the frames 302a,b.

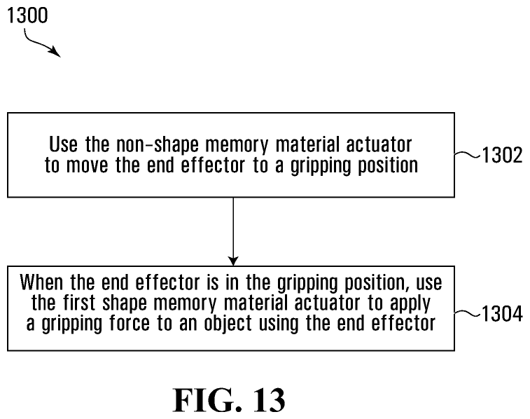

FIG. 13 depicts a flowchart of a method 1300 for using a robotic manipulator that may be implemented using, for example, the hybrid actuator 200. The controller 1202 at block 1302 first uses the non-SMM actuator such as the worm gear DC motor to move an end effector such as the robotic hand 100 to a gripping position. And when the end effector is in the gripping position, at block 1304 the controller 1202 uses at least the first SMM actuator 300a to apply a gripping force to an object using the end effector. The method 1300 may be expressed as computer program code that is stored in a memory comprising part of the controller 1202 and that is executable by a processor comprising part of the controller 1202 such that, when the controller 1202 executes the computer program code, the hybrid actuator 200 performs the method 1300. The computer program code may, for example, implement an overdamped proportional-integral-derivative (“PID”) controller in order to control the end effector.

The hybrid actuator 200 depicted in the figures and described above accordingly allows independent application of forces by the DC motor 1102 and SMM filaments 322a,b; has reduced position error when gripping strength is applied to the robotic joint 204 as shown in FIG. 2B relative to at least some alternative hybrid actuators; provides real-time position feedback using the encoder 306 and IR position sensors 1204a,b; helps keep stress on the SMM filaments 322a,b tolerable by virtue of using pulleys to favorably orient the SMM filaments 322a,b and by monitoring stress on the SMM filaments 322a,b using current sensing; and by using the pulleys and a stacked design that permits forces generated by multiple SMM actuators 300a,b to be combined achieves this in a space efficient manner. Various other embodiments of the hybrid actuator 200 (not depicted) may exemplify only a subset of these features (e.g., it may allow for independent application of forces by the non-SMM actuator and an SMM actuator and result in reduced position error when used in conjunction with the floating pulley 208 of FIG. 2B, but lack pulleys and current/position sensing).

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

The controller 1202 used in the foregoing embodiments may comprise, for example, a processing unit (such as a processor, microprocessor, or programmable logic controller) communicatively coupled to a non-transitory computer readable medium having stored on it program code for execution by the processing unit, microcontroller (which comprises both a processing unit and a non-transitory computer readable medium), field programmable gate array (FPGA), system-on-a-chip (SoC), an application-specific integrated circuit (ASIC), or an artificial intelligence accelerator. Examples of computer readable media are non-transitory and include disc-based media such as CD-ROMs and DVDs, magnetic media such as hard drives and other forms of magnetic disk storage, semiconductor based media such as flash media, random access memory (including DRAM and SRAM), and read only memory.

It is contemplated that any part of any aspect or embodiment discussed in this specification can be implemented or combined with any part of any other aspect or embodiment discussed in this specification.

In construing the claims, it is to be understood that the use of computer equipment, such as a processor, to implement the embodiments described herein is essential at least where the presence or use of that computer equipment is positively recited in the claims.

One or more example embodiments have been described by way of illustration only. This description is being presented for purposes of illustration and description, but is not intended to be exhaustive or limited to the form disclosed. It will be apparent to persons skilled in the art that a number of variations and modifications can be made without departing from the scope of the claims.

1. A shape memory material actuator comprising:
(a) a frame;
(b) a pair of terminals connected to the frame;
(c) a movement mechanism movable relative to the frame; and
(d) a length of shape memory material extending between and connected to the pair of terminals, wherein a portion of the length of shape memory material extending between the pair of terminals also extends over a surface of the movement mechanism such that contraction of the length of shape memory material applies force against and consequently displaces the movement mechanism.

2. The shape memory material actuator of claim 1, further comprising:
(a) a first group of one or more pulleys at one angular position about the movement mechanism; and
(b) a second group of one or more pulleys at another angular position about the movement mechanism, wherein respective portions of the length of shape memory material are reeved through the first and second groups of pulleys and the portion of the length of shape memory material that applies force against the movement mechanism is between the portions of the length of shape memory material that are reeved through the first and second groups of pulleys.

3. The shape memory material actuator of claim 2, wherein each of the pulleys sits on an electrically insulative axle and comprises a metallic sheave.

4. The shape memory material actuator of claim 2, wherein:
(a) the movement mechanism comprises a channel through which the length of shape memory material extends, wherein the surface against which the length of shape memory material applies force comprises a wall of the channel; and
(b) the first group of one or more pulleys comprises a first block and tackle comprising opposing sets of pulleys, the second group of one or more pulleys comprises a second block and tackle comprising opposing sets of pulleys, and wherein the channel is axially positioned along the movement mechanism between the opposing sets of pulleys that comprise the first block and tackle and between the opposing sets of pulleys that comprise the second block and tackle.

5. The shape memory material actuator of claim 1, wherein the contraction of the length of shape memory material causes the movement mechanism to move from an unactuated position to an actuated position, and further comprising a spring positioned to bias the movement mechanism from the actuated position back to the unactuated position.

6. The shape memory material actuator of claim 5, wherein the spring biases the wall of the channel of the movement mechanism against the frame when the movement mechanism is in the unactuated position.

7. The shape memory material actuator of claim 1, wherein the shape memory material comprises a shape memory alloy that contracts in response to an electrical signal.

8. The shape memory material actuator of claim 7, wherein the frame is electrically insulative.

9. The shape memory material actuator of claim 1, further comprising a current sensor electrically coupled to the first pair of terminals for measuring stress experienced by the length of shape memory material of shape memory material.

10. The shape memory material actuator of claim 1, further comprising an infrared position sensor aligned with the movement mechanism and positioned to emit infrared light towards the movement mechanism, wherein a tip of the movement mechanism is convex and infrared reflective.

11. The shape memory material of claim 1, wherein the movement mechanism comprises a piston.

12. A hybrid actuator, comprising:
(a) a first shape memory material actuator comprising the shape memory material actuator of claim 1; and
(b) a non-back drivable non-shape memory material actuator connected to the frame.

13. The hybrid actuator of claim 12, wherein the non-shape memory material actuator comprises:
(a) a worm gear direct current electric motor; and
(b) an output pulley powered by the worm gear direct current electric motor.

14. The hybrid actuator of claim 13, wherein:
(a) the frame comprises a printed circuit board; and
(b) the pair of terminals and the worm gear direct current electric motor are mounted to the printed circuit board.

15. The hybrid actuator of claim 12, further comprising one or more additional shape memory material actuators, wherein each of the one or more additional shape memory material actuators comprises the shape memory material actuator of claim 1, and wherein the movement mechanisms of the first shape memory material actuator and of the one or more additional shape memory material actuators are secured together.

16. A robotic manipulator, comprising:
(a) an end effector comprising a robotic joint, wherein the robotic joint comprises a floating pulley and wherein movement of the floating pulley causes bending of the robotic joint;
(b) a hybrid actuator, comprising:
(i) a first shape memory material actuator; and
(ii) a non-back drivable non-shape memory material actuator; and
(c) an artificial tendon connected to the first shape memory material actuator and the non-shape memory material actuator, wherein a portion of the artificial tendon between where the artificial tendon is connected to the first shape memory material actuator and the non-shape memory material actuator is reeved through the floating pulley.

17. The robotic manipulator of claim 16, wherein the first shape memory material actuator comprises the shape memory material actuator of claim 1, and wherein the artificial tendon is connected to the movement mechanism of the first shape memory material actuator.

18. The robotic manipulator of claim 17, wherein the non-shape memory material actuator comprises:
(a) a worm gear direct current electric motor; and
(b) an output pulley powered by the worm gear direct current electric motor, and wherein at least some of the second artificial tendon is reeved through the output pulley.

19. The robotic manipulator of claim 18, wherein:
(a) the frame comprises a printed circuit board; and
(b) the pair of terminals and the worm gear direct current electric motor are mounted to the printed circuit board.

20. The robotic manipulator of claim 17, further comprising one or more additional shape memory material actuators, wherein each of the one or more additional shape memory material actuators comprises the shape memory material actuator of claim 1, and wherein the movement mechanisms of the first shape memory material actuator and of the one or more additional shape memory material actuators are secured together.

21. The robotic manipulator of claim 20, wherein the one or more additional shape memory material actuators are secured together using one or more connectors, and the first artificial tendon is attached to the one or more connectors.

22. The robotic manipulator of claim 16, further comprising a controller communicatively coupled to the hybrid actuator and configured to:
(a) use the non-shape memory material actuator to move the end effector to a first position; and
(b) when the end effector is at the first position, using the first shape memory material actuator to apply a gripping force to an object using the end effector.

23. The robotic manipulator of claim 16, wherein the robotic manipulator comprises a robotic hand and the hybrid actuator is located outside of a finger comprising part of the robotic hand.

24. A method for using the robotic manipulator of claim 16, the method comprising:
(a) using the non-shape memory material actuator to move the end effector to a gripping position; and
(b) when the end effector is in the gripping position, using the first shape memory material actuator to apply a gripping force to an object using the end effector.
